(19) United States
(12) Patent Application Publication
(10) Pub. No.: US 2011/0041556 A1
(43) Pub. Date: Feb. 24, 2011

(54) GLASS SURFACE MODIFICATION PROCESS

(75) Inventors: Markku Rajala, Vantaa (FI); Matti Putkonen, Espoo (FI); Sampo Ahonen, Espoo (FI); Joe Pimenoff, Helsinki (FI); Anssi Hovinen, Espoo (FI); Sami Sneck, Vantaa (FI)

Correspondence Address: OLIFF & BERRIDGE, PLC, P.O. BOX 320850, ALEXANDRIA, VA, 22320-4850, US

(73) Assignee: BENEQ OY, VANTAA (FI)

(21) Appl. No.: 12/811,714

(22) PCT Filed: Feb. 17, 2009
(86) PCT No.: PCT/FI09/00026

§ 371 Date: Aug. 17, 2010

(30) Foreign Application Priority Data
Feb. 18, 2008 (FI) 20080128

(51) Int. Cl. C03C 17/23

(52) U.S. Cl. 65/30.1

(57) ABSTRACT

Process for improving the chemical durability of glass by modifying at least one surface of a glass substrate. The modification process utilizes crystalline metal oxide particles with a mean aerodynamic particle diameter of less than 1000 nm, which are at least partially embedded on and into the glass surface. Apparatus for depositing crystalline metal oxide particles on glass surface.

### BACKGROUND OF THE INVENTION

1. Field of Invention

The invention relates to a process for improving the chemical durability of glass by modifying a surface of a glass substrate. The surface modification is preferably carried out during glass manufacturing or during glass processing, such as glass tempering. The chemical durability of the glass is improved by crystalline aluminium oxide particles at least partially embedded in the glass. The deposition of the particles comprising aluminium is preferably carried out by a modified liquid flame spraying process.

2. Description of the State of the Art

Aluminium oxide (Al₂O₃) coatings are used in various applications, such as optics and electronics. Aluminium oxide coatings are scratch resistant and they have been used on various substrate materials, e.g., on metal, semiconductor and glass substrates. Various coating methods have been used to deposit aluminium oxide coatings, including chemical vapour deposition (CVD), spray pyrolysis and sputtering.

It is well known that the chemical durability of glass can be improved by adding aluminium oxide or zirconium oxide to the glass batch. Simultaneously, however, the melting temperature of the batch needs to be increased, in order to maintain the necessary viscosity of the glass melt, which greatly increases glass production cost.

The use of an atmospheric CVD process for producing coatings on glass ribbon is a well-known process. Various precursors have been used to produce aluminium oxide coatings on the glass ribbon as explained in WO 2005/087678 A1, Pilkington North America Inc., 22, Sep. 2005. The publication describes the production of Al₂O₃ coating on glass. Such a coating does not modify the surface of the glass substrate, but is a separate coating on glass. The adhesion of the coating and especially the changes in the adhesion over time, due to, e.g., environmental effects, are a great challenge to the chemical durability of the glass product.

U.S. Pat. No. 3,762,808, Pilkington Brothers Ltd., 2, Oct. 1973, describes a process for modifying glass properties during the float process. The surface characteristics of glass, e.g., the tint, light transmission and heat rejection characteristics of float glass are modified by causing electrolytic migration of two metals into the glass surface in desired proportions from a body of molten alloy which is maintained in contact with the hot glass surface. The requirement of the molten metal makes the process cumbersome in the float process and impossible in glass processing.

The problem of the prior art is that it does not provide a process which improves the chemical durability of glass and which can be integrated to the glass manufacturing process, such as float process or casting process, or to a glass processing line, such as glass tempering.

### SUMMARY OF THE INVENTION

The main purpose of the present invention is to introduce a process to be used for improving the chemical durability of glass by modifying at least one surface of a glass substrate. The modification process utilizes crystalline metal oxide particles with a mean aerodynamic particle diameter of less than 1000 nm, which are at least partially embedded on and into the glass surface.

In one embodiment of the invention, at least one glass substrate surface is heated to a temperature above 550° C. Particles comprising precursor metal, M, are deposited on at least one surface of the glass substrate and at least part of the deposited particles are converted, by a thermal treatment to particles comprising crystalline metal oxide, MₓO_{y}(c). In another embodiment of the invention, at least one glass substrate surface is heated to a temperature above 550° C. Crystalline metal oxide particles, MₓO_{y}(c), with a mean aerodynamic particle diameter of less than 1000 nm are formed and deposited to at least one surface of a glass substrate where the temperature of the surface is above 550° C. and the temperature of the aerosol containing said particles, MₓO_{y}(c), is higher than the temperature of the glass surface. The particles are preferably produced by gas-to-particle conversion. The size of the particles is preferably less than 1000 nm, more preferably less than 100 nm and most preferably less than 50 nm.

The metal is preferably aluminium or zirconium. Aluminium oxide (Al₂O₃) particles are preferably α-Al₂O₃ particles and they are preferably converted to γ-Al₂O₃ particles by a thermal treatment process. Zirconium oxide particles are preferably tetragonal or monoclinic.

Another purpose of the present invention is to introduce an apparatus for improving the chemical durability of glass by modifying at least one surface (9) of a glass substrate (8). The apparatus comprises a body (1), a liquid flame spraying gun (2) attached to the body (1) and comprising an atomizer (11), conduit (5) for feeding at least one liquid precursor to the spraying gun (2) and means (12) for generating a flame (6). The distance between the flame (6) and the glass surface (9) is arranged so that the temperature of the flame (6) essentially on the surface (9) is higher than the temperature of the surface (9). In a preferred embodiment the flame (6) temperature essentially on the surface (9) is at least 650° C.

### BRIEF DESCRIPTION OF THE DRAWINGS

In the following, the invention will be described in more detail with reference to the appended principle drawing, in which

FIG. 1 shows a schematic drawing of the invented apparatus.

For the sake of clarity, the figure only shows the details necessary for understanding the invention. The structures and details which are not necessary for understanding the invention and which are obvious for a person skilled in the art have been omitted from the figure in order to emphasize the characteristics of the invention.

### DETAILED DESCRIPTION OF PREFERRED EMBODIMENTS

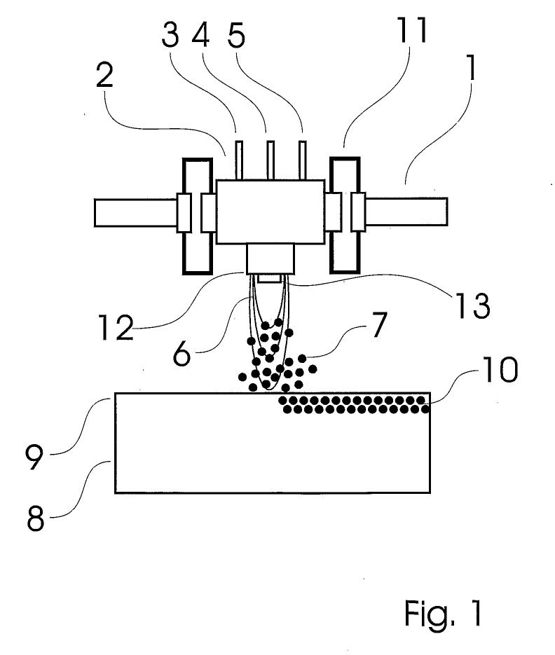

FIG. 1 shows, in principle, the use of a modified liquid flame spraying apparatus 2 for modifying at least one surface 9 of a glass substrate 8 by the invented process. At least one liquid flame spraying gun 2 is attached to a body 1. The apparatus comprises means 11 for adjusting the distance between the spray gun 2 and the glass substrate surface 9. The distance is adjusted so that the temperature of the flame 6 on the surface 9 is higher than the temperature of the surface 9. The temperature of the flame 6 can be adjusted by the amount of fuel and oxidizing gases fed into the liquid flame spraying apparatus 2 through conduits 3 and 4, respectively. The temperature of the flame 6 can also be adjusted by the selection of the fuel gas and the oxidizing gas. For high flame 6 temperatures the preferred mix is hydrogen and oxygen, for lower flame 6 temperatures air can be used instead of oxygen and hydrocarbons instead of hydrogen. Liquid precursor is fed into the gun 2 through conduit 5. The precursor can be, e.g., a solution of metal nitrate. In case of aluminium, the liquid precursor is preferably aluminium nitrate, Al(NO₃)₃.9H₂O dissolved in methyl alcohol. The aluminium nitrate:methyl alcohol ratio is preferably 1:10-1:100 by weight, most preferably about 1:30. The precursor flow rate to a single gun 2 is preferably 1-100 ml/min, most preferably about 10 ml/min. Hydrogen gas is fed through conduit 3. The typical mass flow is 5-50 l/min for a single gun 2, preferably about 30 l/min. Oxygen gas is fed through conduit 4. The typical mass flow is 2-30 l/min for a single gun 2, preferably about 15 l/min. Hydrogen gas and oxygen gas flows through the means 12 for generating a flame 6 and the flame 6 is ignited. The liquid precursor is fed into the flame 6 through an atomizer 11 which turns the liquid precursor into small droplets. The droplets and the precursor metal evaporate in flame 6 and submicron particles 7 are formed through gas-to-particle conversion. With the described aluminium precursor, γ-Al₂O₃ particles 7 are formed. The mean aerodynamic diameter of the particles 7 is preferably less than 1000 nm, more preferably less than 100 nm and most preferably less than 50 nm, this size being so small that the particles 7 do not cause significant optical effects on the glass surface 9. We have discovered that the γ-Al₂O₃ particles 10 which are at least partially embedded in the glass surface layer 9 can be converted to α-Al₂O₃ particles by a thermal treatment at a temperature between 500 and 750° C. Depending on the temperature of the glass substrate 8 and more precisely on the temperature of the glass surface layer 9, smaller or higher fraction of the precursor metal may dissolve from the metal oxide particles 7 into the surface layer 2. This decreases the mean diameter of the crystalline metal oxide particles 11, which is advantageous to the optical quality of the glass substrate 8. In one embodiment of the invention the distance between the flame 6 and the substrate surface 9 is adjusted so that the temperature of the flame 6 on the surface 9 is higher than the temperature of the surface 9. Preferably the flame 6 temperature on surface 9 is at least 650° C. and more preferably at least 750° C.

It is also possible to adjust the liquid atomization and the temperature of the flame 6 so that the particles 7 are not formed by gas-to-particle conversion route, but rather through spray drying. This mechanism produces considerably larger particles, having a typical diameter of about 1000 nm. These particles can be deposited on the surface 9 and by a thermal treatment between 500-750° C. turn them into crystalline particles. Such a thermal treatment process can be advantageously carried out in the float glass manufacturing process or in the glass casting process, which are well known processes for a person skilled in the art.

Zirconium nitrate, ZrO(NO₃)₂ is a preferred precursor for the production of crystalline ZrO₂. ZrO(NO₃)₂ can be produced, e.g., from Zr(OH₂)CO₃ powder. Concentrated nitric acid can be used to dissolve the powder and de-ionised water (H₂O) and ethanol can then be used to obtain the liquid precursor. In the flame the precursor evaporates and crystalline ZrO₂ is produced. Typically both the metastable tetragonal phase and the monoclinic phase of ZrO₂ can be identified. It is assumed that the metastable phase may be dominant in the smaller particles 7.

It is possible to produce various embodiments of the invention in accordance with the spirit of the invention. Therefore, the above-presented example must not be interpreted as restrictive to the invention, but the embodiments of the invention can be freely varied within the scope of the inventive features presented in the claims herein below.

1. A process for improving the chemical durability of glass by modifying at least one surface of a glass substrate, where crystalline metal oxide, MₓO_{y}(c), particles with a mean aerodynamic particle diameter of less than 1000 nm are embedded on and into the glass surface, comprising:
a. heating at least one surface of the glass substrate to a temperature above 550° C.;
b. depositing particles comprising precursor metal M on at least one surface of the glass substrate; and
c. a thermal treatment process sufficient for turning at least part of the deposited particles comprising metal M, into particles comprising crystalline metal oxide, MₓO_{y}(c).

2. The process as in claim 1, wherein the metal is aluminum.

3. The process as in claim 1, wherein the metal is zirconium

4. The method of claim 2, wherein the aluminum oxide, Al₂O₃, particles are γ-Al₂O₃ particles.

5. The method of claim 4 further comprising a thermal treatment process sufficient for turning at least part of the deposited γ-Al₂O₃ particles to α-Al₂O₃— particles.

6. The method as in claim 1 comprising producing the particles by gas-to-particle conversion.

7. The method as in claim 2 comprising producing the particles by gas-to-particle conversion.

8. The method as in claim 3 comprising producing the particles by gas-to-particle conversion.

9. The method as in claim 4 comprising producing the particles by gas-to-particle conversion.

10. The method as in claim 5 comprising producing the particles by gas-to-particle conversion.
